(19) United States
(12) Patent Application Publication
(10) Pub. No.: US 2025/0262718 A1
(43) Pub. Date: Aug. 21, 2025

(54) CONNECTOR AND MACHINING APPARATUS

(71) Applicant: MAKITA CORPORATION, Anjo-shi (JP)

(72) Inventors: Tsuyoshi KURODA, Anjo-shi (JP); Norito Chikusa, Anjo-shi (JP); Fumihide Sugita, Anjo-shi (JP)

(73) Assignee: MAKITA CORPORATION, Anjo-shi (JP)

(21) Appl. No.: 19/050,841

(22) Filed: Feb. 11, 2025

(30) Foreign Application Priority Data
Feb. 20, 2024 (JP) 2024-023878

(51) Int. Cl. B24B 55/10

(52) U.S. Cl. CPC B24B 55/10

(57) ABSTRACT

A connector configured to connect a machining apparatus and a dust collection device includes a through-hole configured to establish communication between the machining apparatus and the dust collection device, and an outer surface made of a static dissipative material.

### TECHNICAL FIELD

The present invention relates to a connector and a machining apparatus.

### BACKGROUND

As one type of machining apparatus, sanders have been known conventionally. For example, orbital sanders as one type of sander cause a pad coupled to one end of an output shaft (for example, a motor shaft) to perform an eccentric circular motion (an orbital motion). Sanding paper is attached to the pad. Sanding work can be performed by pressing the sanding paper against a workpiece.

Many types of sanders include a dust collection nozzle for guiding dust generated due to the sanding to a dust collector. A dust collection device (for example, a dust collector or a dust bag) for collecting the dust is connected to the dust collection nozzle via a connector and/or a hose.

The dust is collected into the dust collection device in a state of being positively or negatively charged due to friction, and this leads to a accumulation of charges in a range from the connector and/or the hose to the dust collection device. The charges accumulated in this manner bring about static electricity of a high potential unless a route for discharging these charges is sufficiently secured. Therefore, when a user's hand contacts or approaches a portion having a high potential during the sanding work, an electric discharge to the user's hand occurs and invokes an unpleasant feeling in the user. For such a reason, a floor standing-type dust collector connected to the dust collection nozzle via the hose is configured to release the static electricity using an earth wire.

On the other hand, the earth connection cannot be secured for a dust collection device that is not installed on a floor surface or the ground surface when in use. In consideration thereof, Japanese Patent Application Laid-Open No. H11-291170 discloses a technique for connecting a sander and a dust bag via a cuff made of conductive resin. According to this technique, when dust contacts the cuff in the course of being guided from a dust collection nozzle to a dust box, charges of the dust are guided into the sander via an earth plate in contact with the cuff. This makes it difficult for an unpleasant electric discharge to the user's hand to occur

Further, Japanese Patent Application Laid-Open No. H11-138435 discloses a technique for connecting a dust collection nozzle and a dust bag. More specifically, a connector (an attachment portion) of the dust bag includes flexible claw portions, and the claw portions are engaged with stepped portions of the dust collection nozzle. This makes it difficult for the connection to be disengaged compared with a configuration in which two tapered tubular bodies are simply fitted to each other.

### SUMMARY

The present specification discloses a connector configured to directly or indirectly connect a machining apparatus and a dust collection device. This connector may include a through-hole configured to establish communication between the machining apparatus and the dust collection device, and an outer surface made of a static dissipative material.

The above-described connector can be used as a part of the dust collection device. In this case, the connector can be detachably attached to a dust collection nozzle of the machining apparatus. Alternatively, the above-described connector can be undetachably or detachably attached to a dust conveyance means (typically, a hose) connected to the dust collection device, and, further, can be detachably attached to the dust collection nozzle of the machining apparatus. According to this connector, the outer surface of the connector is made of the static dissipative material, and this makes it difficult for an unpleasant electric discharge from the connector to a user's hand to occur even when the user brings his/her hand close to the connector in a state that a range from the connector to the dust collection device is charged with static electricity of a high potential when the user connects the machining apparatus and the dust collection device via the connector to conduct machining, compared with a connector made of a conductive material. Further, the outer surface of the connector is made of the static dissipative material, and therefore static electricity accumulated at a portion closer to the dust collection device than the connector can be released to the machining apparatus via the connector compared with a connector made of an insulating material. This makes it difficult for the range between the connector and the dust collection device to be charged with static electricity of a high potential.

The present specification further discloses a connector configured to directly or indirectly connect a machining apparatus and a dust collection device. The connector may include a rubber sleeve made of a conductive material and including an inner circumferential surface with a circumferentially extending recessed portion and/or protrusion portion defined thereon, and a cover made of an insulating material and disposed outside the rubber sleeve so as to surround the rubber sleeve.

The above-described connector can be detachably attached by press-fitting a dust collection nozzle of the machining apparatus into the connector. In this case, the dust collection nozzle may include a protrusion portion and/or recessed portion engageable with the recessed portion and/or the protrusion portion of the rubber sleeve. According to this connector, the dust collection nozzle of the machining apparatus and the dust collection device can be easily connected and disconnected via the rubber sleeve. Further, since the cover surrounding the rubber sleeve made of the conductive material is made of the insulating material, an unpleasant electric discharge from the connector to the user's hand does not occur. In addition, since the rubber sleeve is made of the conductive material, static electricity of the connector (or the dust collection device) can be released to the machining apparatus.

The present specification further discloses a machining apparatus. This machining apparatus may include a dust collection nozzle for discharging dust generated due to machining out of the machining apparatus. The dust collection nozzle may include a first engagement portion for a twist lock and a second engagement portion for press-fit engagement.

According to the above-described machining apparatus, a connector having the twist lock structure and a connector having the press-fit engagement structure can be selectively attached to the dust collection nozzle. This leads to an increase in the number of types of connectors attachable to the dust collection nozzle, thereby improving the versatility of the dust collection nozzle. Therefore, the machining apparatus and the dust collection device can be connected with improved convenience.

### BRIEF DESCRIPTION OF THE DRAWINGS

FIG. 1 is a perspective view of a sander according to a first embodiment.

FIG. 2 is a perspective view of the sander.

FIG. 3 is a left side view of the sander.

FIG. 4 is a plan view of the sander.

FIG. 5 is a longitudinal sectional view of the sander taken along a line A-A illustrated in FIG. 4.

FIG. 6 is a longitudinal sectional view of the sander taken along a line B-B illustrated in FIG. 5.

FIG. 7 is a transverse sectional view of the sander taken along a line C-C illustrated in FIG. 6.

FIG. 8 is a partial enlarged perspective view around a dust collection nozzle.

FIG. 9 is a partial enlarged perspective view around the dust collection nozzle.

FIG. 10 is a perspective view of a dust bag according to the first embodiment.

FIG. 11 is a cross-sectional view of the dust bag.

FIG. 12 is a perspective view of a connector according to the first embodiment.

FIG. 13 illustrates one example of the sander in use.

### DETAILED DESCRIPTION OF THE EMBODIMENTS

Representative and non-limiting specific examples of the present invention will be described in detail below with reference to the drawings. This detailed description is merely intended to teach a person of skill in the art details for practicing preferred examples of the present invention and is not intended to limit the scope of the present invention. Furthermore, each of additional features and inventions disclosed below can be utilized separately from or together with the other features and inventions to provide further improved apparatuses and methods for manufacturing and using the same.

Moreover, combinations of features and steps disclosed in the following detailed description are not necessary to practice the present invention in the broadest sense, and are instead taught merely to particularly describe a representative specific example of the present invention. Furthermore, various features of the above-described and the following representative examples, as well as various features recited in the independent and dependent claims below, do not necessarily have to be combined in herein specifically exemplified manners or enumerated orders to provide additional and useful embodiments of the present invention.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges and indications of groups or aggregations are intended to disclose every possible intermediate individual forming them for the purpose of original written disclosure, as well as for the purpose of restricting the claimed subject matter.

In one or more embodiments, surface resistivity of the outer surface may be equal to or higher than 1×10⁵ (Ω/sq.) and equal to or lower than 1×10¹³ (Ω/sq.). This configuration makes it difficult for an unpleasant electric discharge from the connector to the user's hand to occur. In one or more embodiments, the surface resistivity of the outer surface may be equal to or higher than 1×10⁷ (Ω/sq.) and equal to or lower than 1×10¹² (Ω/sq.).

In one or more embodiments, the connector may include a claw portion for a twist lock usable for the connection to the machining apparatus. This connector can be attached to the dust collection nozzle in such a manner that, for example, the claw portion for the twist lock is engaged with a flange portion defined on an outer circumferential surface of the dust collection nozzle. According to this configuration, the connection force between the connector and the dust collection nozzle of the machining apparatus is enhanced and makes it difficult for the connector to be disengaged from the dust collection nozzle.

In one or more embodiments, the connector may include a rubber sleeve including an inner circumferential surface with a circumferentially extending recessed portion and/or protrusion portion defined thereon. This connector can be attached to the dust collection nozzle in such a manner that, for example, the recessed portion and/or the protrusion portion of the rubber sleeve is fitted to a protrusion portion and/or a recessed portion extending circumferentially on the outer circumferential surface of the dust collection nozzle. According to this configuration, the connector and the dust collection nozzle of the machining apparatus can be easily attached and detached. Further, the connection force between the connector and the dust collection nozzle of the machining apparatus can be enhanced compared to a structure in which tapered tubular bodies not having a recess and a protrusion are fitted to each other.

In one or more embodiments, a machining apparatus may be provided. This machining apparatus may include any of the above-described connectors, and a dust collection nozzle connectable to the connector. According to this machining apparatus, advantageous effects similarly to any of the above-described connectors can be acquired.

In one or more embodiments, the machining apparatus may include a metallic earth member disposed in contact with the connector with the connector attached to the dust collection nozzle. According to this configuration, the static electricity charged between the connector and the dust collection nozzle can be efficiently released via the metallic earth member.

In one or more embodiments, the machining apparatus may include a metallic power transmission member, and may be configured to release static electricity from the connector to the power transmission member. According to this configuration, the static electricity charged between the connector and the dust collection nozzle can be efficiently released via the metallic power transmission member. Further, the power transmission member originally existing in the machining apparatus is used as the route for releasing the static electricity, and this reduces the necessity of additional members and specifications for releasing the static electricity and contributes to the simplification of the apparatus configuration.

In one or more embodiments, the machining apparatus may include a grip portion configured to be held by a user with his/her hand during machining, and may be configured to release the static electricity from the connector to the grip portion. According to this configuration, the connector and the grip portion (and thus the user gripping the grip portion) are constantly kept at equal potentials during the machining work, and this makes it further difficult for an electric discharge considerable to the degree that the user feels unpleasant to occur.

In one or more embodiments, the grip portion may include an outer surface at least partially made of conductive resin or a static dissipative material. According to this configuration, the static electricity can be efficiently released from the connector to the grip portion (and thus the user gripping the grip portion).

In one or more embodiments, the outer surface of the grip portion may be at least partially made of conductive elastomer. According to this configuration, the static electricity can be efficiently released from the connector to the grip portion (and thus the user gripping the grip portion). In addition, the user can feel an excellent fit when gripping the grip portion.

In one or more embodiments, the machining apparatus may include a direct-current motor disposed right below the grip portion. According to this configuration, the required insulation distance between the grip portion and the electric motor is shortened, and the first grip portion and the electric motor can be disposed at positions closer to each other, compared to when an alternating-current motor is employed. Therefore, the machining apparatus can have a compact size. Especially, using the motor shaft as the route for releasing the static electricity allows the static electricity to be released from the connector to the grip portion via a shorter route, thereby contributing to the simplification of the apparatus configuration.

In one or more embodiments, the dust collection nozzle may have a generally circular cylindrical shape. The first engagement portion may include a flange portion defined on an outer circumferential surface of the dust collection nozzle engageably with a claw portion of a connector configured to directly or indirectly connect the dust collection nozzle to a dust collection device. According to this configuration, the dust collection nozzle of the machining apparatus and the connector can be reliably connected with the aid of the engagement between the flange portion of the dust collection nozzle and the claw portion of the connector.

In one or more embodiments, the flange portion may include a helical lead surface. According to this configuration, an axial force is applied at the time of the engagement between the flange portion of the dust collection nozzle and the claw portion of the connector, and therefore the dust collection nozzle of the machining apparatus and the connector can be further robustly connected.

In one or more embodiments, the second engagement portion may include a protrusion portion and/or a recessed portion circumferentially extending on the outer circumferential surface of the dust collection nozzle engageably with a recessed portion and/or a protrusion portion extending circumferentially on an inner circumferential surface of a rubber sleeve of the connector. The protrusion portion and/or the recessed portion of the second engagement portion may be located between a distal end and the flange portion of the dust collection nozzle. According to this configuration, the connector and the dust collection nozzle of the machining apparatus can be easily attached and detached, and the connection force can be enhanced using the engagement based on the recessed/protrusion shape.

In the following description, a sander 10 as an exemplary first embodiment will be described in further detail with reference to the drawings. The sander 10 is also referred to as a random orbit sander.

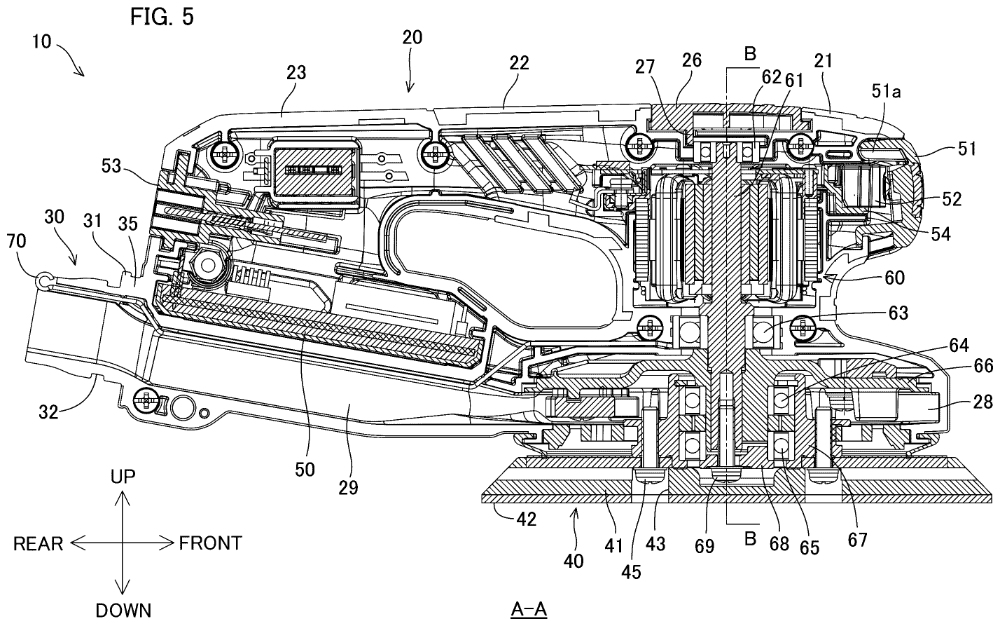

As illustrated in FIG. 5, the sander 10 includes an electric motor 60, a motor shaft 61, and a tool accessory 40. One end of the motor shaft 61 is coupled with the tool accessory 40 via another member. As will be described in detail below, the sander 10 is configured in such a manner that the tool accessory 40 performs a sanding motion with the aid of a rotation of the electric motor 60 (the motor shaft 61).

As will be used in the following description, an up-down direction of the sander 10 is defined to be a direction in which the motor shaft 61 extends. A lower side and an upper side are defined to be one side in the up-down direction on which the tool accessory 40 is located, and the opposite side therefrom, respectively. Further, a front-rear direction of the sander 10 is defined to be the longitudinal direction of the sander 10 orthogonal to the up-down direction. A front side and a rear side are defined to be one side in the front-rear direction on which the tool accessory 40 is located, and the opposite side therefrom, respectively. Further, a left-right direction of the sander 10 is defined to be a direction orthogonal to the front-rear direction and the up-down direction. A right side and a left side of the sander 10 are defined to be a right side in the left-right direction when the front side is viewed from the rear side, and the opposite side therefrom, respectively.

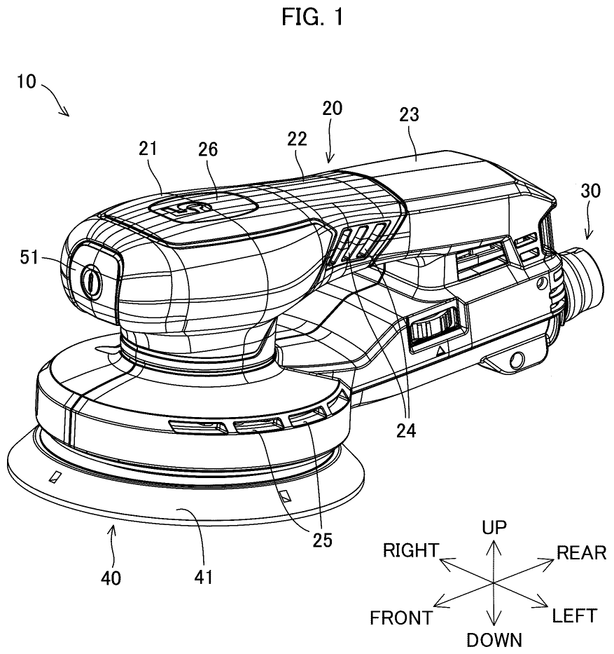

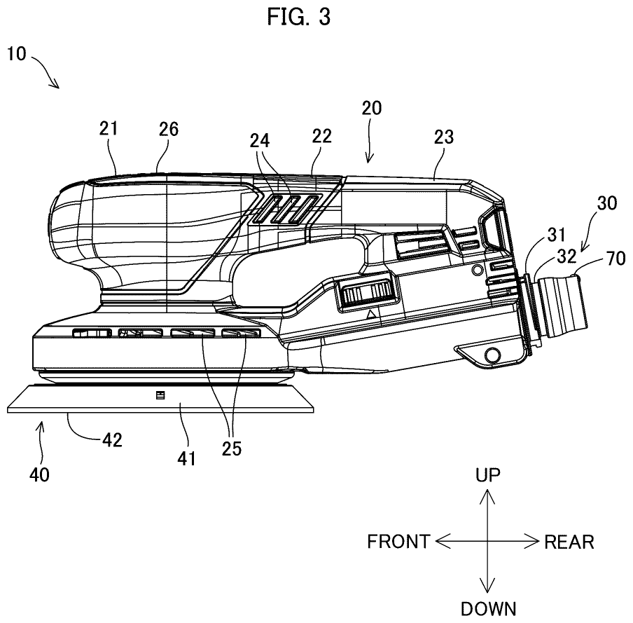

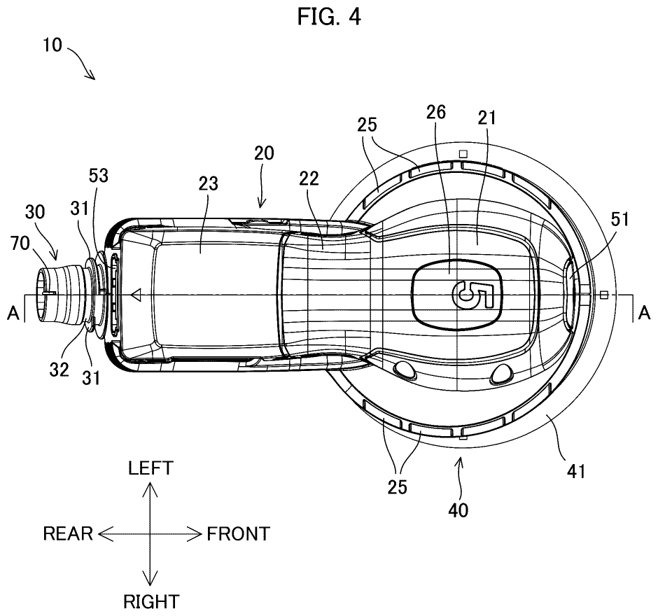

As illustrated in FIGS. 1 to 4, the sander 10 includes a housing 20. The housing 20 includes a front housing portion 21, a connection portion 22, and a rear housing portion 23. The front housing portion 21 and the rear housing portion 23 are connected in the front-rear direction via the connection portion 22 having a forked form spaced apart in the up-down direction. A top portion of the front housing portion 21 functions as a first grip portion. The first grip portion is a portion intended to be gripped by a user when the user performs sanding work. An upper portion of the forked form of the connection portion 22 functions as a second grip portion. The second grip portion is a portion intended to be gripped by the user when the user carries the saner 10.

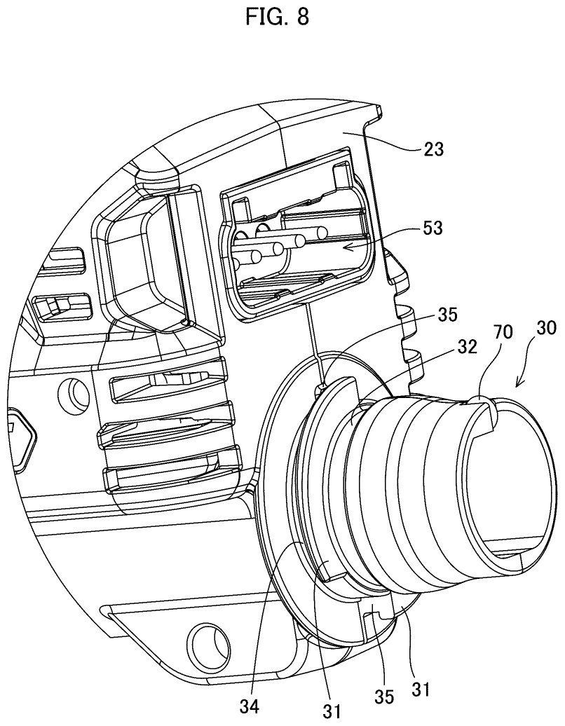

A power connector jack 53 (illustrated in detail in FIG. 8) having electric connection terminals is disposed on the rear surface of the rear housing portion 23. A power connector plug (not illustrated) is detachably connected to the power connector jack 53. A power cord (not illustrated) extending out of the power connector plug is connected to a battery holster (not illustrated) on which a battery (not illustrated) is mountable. The power connector jack 53 receives a direct-current power source of the sander 10 from the battery mounted on the battery holster. The sander 10 may include a battery attachment portion on which the battery is detachably mountable instead of the power connector jack 53. Alternatively, a power cord or a power cable for supplying a commercial AC power source may extend out of the rear housing portion 23 instead of the power connector jack 53.

As illustrated in FIG. 5, a controller 50 is contained in the lower portions of the connection portion 22 and the rear housing portion 23. The controller 50 is electrically connected to the power connector jack 53 and the electric motor 60, and controls the operation of the electric motor 60 by controlling electricity supplied to the electric motor 60. The electric motor 60 is a DC brushless motor, and the controller 50 performs PWM control of the electric motor 60. As illustrated in FIG. 1, a switch button 51 is located at the front portion of the front housing portion 21. The switch button 51 is used to perform an operation of starting up and stopping the electric motor 60. As illustrated in FIG. 5, a switch unit 52 is disposed in the rear of the switch button 51. The switch unit 52 is electrically connected to the controller 50, and detects an ON/OFF operation of the switch button 51 to input an ON/OFF signal to the controller 50. The switch button 51 includes a hinge shaft 51a on the upper portion thereof. The hinge shaft 51a extends in the left-right direction. The switch button 51 swings rearward around the hinge shaft 51a when being operated by being pushed rearward. The switch button 51 is swung rearward and pushes the front portion (a plunger) of the switch unit 52 disposed in the rear of the switch button 51.

As illustrated in FIG. 5, the electric motor 60 is contained in the front housing portion 21. In the present embodiment, the electric motor 60 is a direct-current motor. The electric motor 60 is disposed right below the first grip portion (i.e., the top portion of the front housing portion 21). Employing the direct-current motor as the electric motor 60 leads to a reduction in the required insulation distance between the first grip portion and the electric motor 60, thereby allowing the first grip portion and the electric motor 60 to be disposed at positions closer to each other, compared to when employing an alternating-current motor. Therefore, the sander 10 can have a compact size. However, an alternating-current motor may be employed as the electric motor 60. The motor shaft 61 of the electric motor 60 extends in the up-down direction, and is rotatably supported by bearings 62 and 63 fixed to the front housing portion 21. The bearing 62 supports the upper end of the motor shaft 61, and the bearing 63 supports near the center of the motor shaft 61.

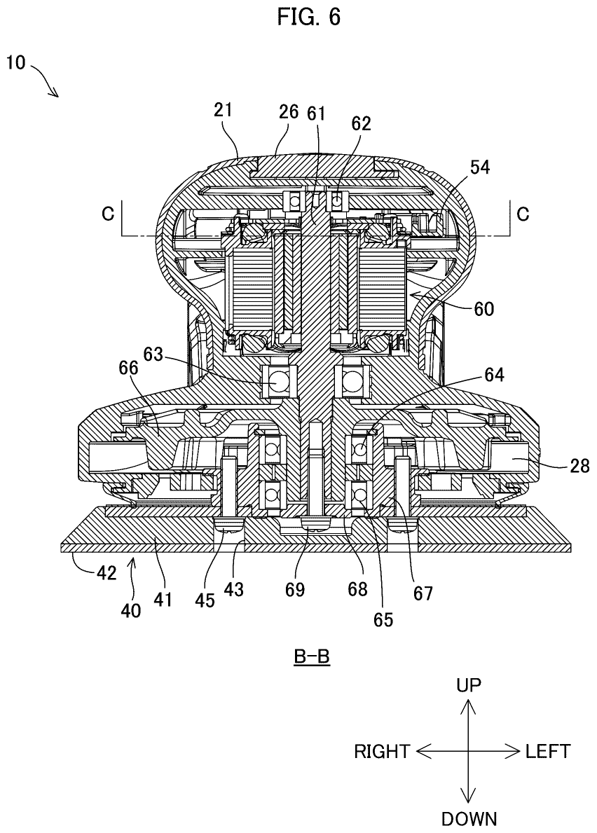

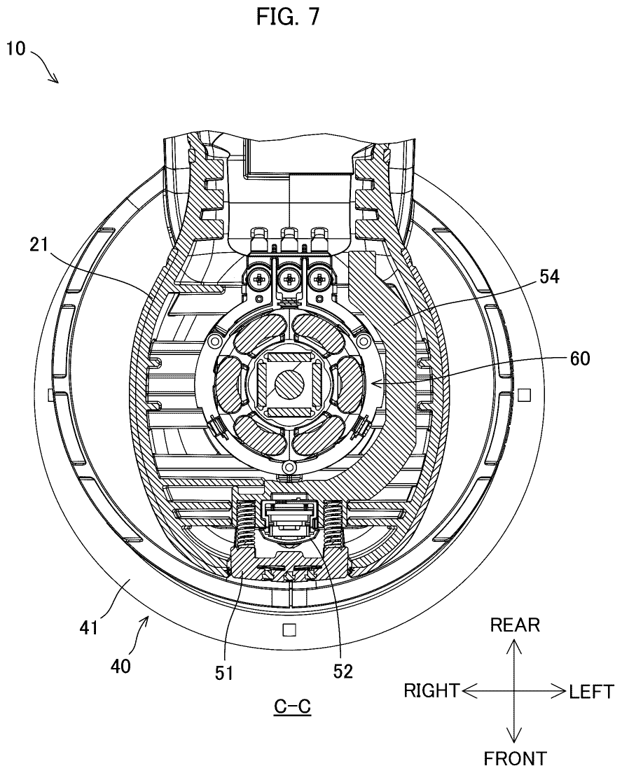

As illustrated in FIGS. 5 to 7, a switch holder 54 is disposed between the bearing 62 and the bearing 63. The switch holder 54 has a shape extending in the front-rear direction. As illustrated in FIG. 5, the front edge of the switch holder 54 has a box-like shape opened on the top and the front thereof, and contains the switch unit 52 therein. The switch holder 54 has a generally U-like shape opened on the top thereof in the rear of the front edge of the switch holder 54 (refer to FIG. 6), and extends in the front-rear direction on the left side of the electric motor 60 so as to avoid the electric motor 60. A lead wire for connecting the switch unit 52 and the controller 50 is contained in a groove defined due to this generally U-like shape. The lead wire can be prevented from contacting the electric motor 60 by placing this lead wire in the switch holder 54. Further, arranging the switch holder 54 between the bearing 62 and the bearing 63 allows the height (the dimension in the up-down direction) of the sander 10 to be shortened by an amount corresponding to the space required for laying the lead wire, compared with a conventional technique in which the lead wire is disposed so as to pass through above the bearing 62.

A fan 66 is disposed below the bearing 63. The fan 66 is fixed to the motor shaft 61 so as to surround the motor shaft 61 circumferentially. In the present embodiment, the fan 66 has a function as a motor cooling fan and a function as a dust collection fan. More specifically, the upper portion of the fan 66 functions as a motor cooling fan, and the lower portion of the fan 66 functions as a dust collection fan.

When the fan 66 is rotated according to the rotation of the motor shaft 61, air flows into the housing 20 from outside via intake ports 24 (refer to FIG. 1) defined on the connection portion 22. This air flows axially (in the direction in which the motor shaft 61 extends) through the electric motor 60 and is directed radially outward by the fan 66, and is exhausted out of the housing 20 via exhaust ports 25 (refer to FIG. 1) defined on the front housing portion 21. The electric motor 60 is cooled with the aid of such a flow of air.

As illustrated in FIG. 5, a containing space 28 of the fan 66 in the front housing portion 21 is in communication with a dust collection passage 29 extending in the front-rear direction in the lower portion of the rear housing portion 23. As illustrated in FIG. 5, the dust collection passage 29 is in communication with a dust collection nozzle 30. The dust collection nozzle 30 extends rearward from the lower and rear edge portion of the rear housing portion 23. A dust collection device is directly or indirectly connected to the dust collection nozzle 30 (as will be described in detail below).

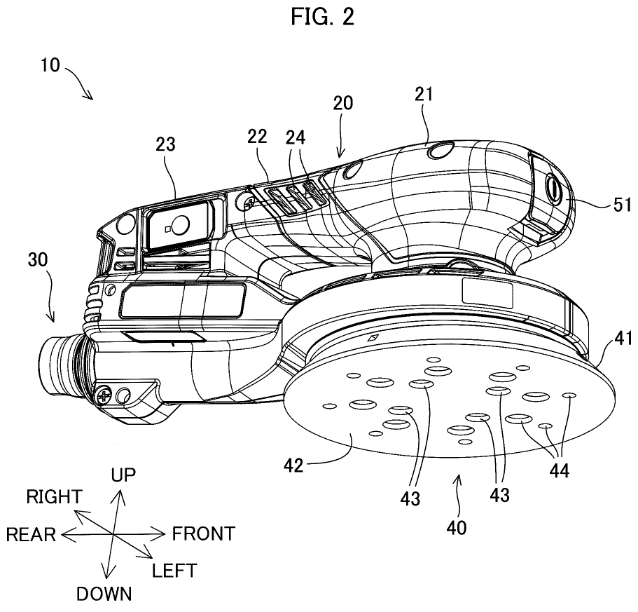

As illustrated in FIGS. 1 to 3, the tool accessory 40 is located at the lowermost portion of the sander 10, and includes a pad 41. The pad 41 is circular as viewed in the up-down direction. The pad 41 includes a flat surface 42 (refer to FIG. 2) for attaching sanding paper (not illustrated). The flat surface 42 is a bottom surface of the pad 41, and expands horizontally (in a direction orthogonal to the up-down direction). As illustrated in FIG. 2, the pad 41 includes four attachment holes 43 and a plurality of flow holes 44.

The plurality of flow holes 44 is in communication with the containing space 28 via an inner space in the pad 41. Sanding paper (not illustrated) is attached to the bottom surface of the pad 41. Holes are defined on the sanding paper at positions corresponding to the through-holes 44 of the pad 41.

When the fan 66 is rotated according to the rotation of the motor shaft 61, air that contains dust generated due to the sanding work flows into the containing space 28 via the holes of the sanding paper and the flow holes 44. At this time, the air is guided radially outward by the fan 66. The air directed in this manner enters the dust collection passage 29 and flows into the dust collection device via the dust collection nozzle 30. The dust generated during the sanding work can be collected into the dust collection device with the aid of the flow of air.

The bearing box 67 is rotatably supported by bearings 64 and 65 disposed on a shaft portion (a circular cylindrical portion extending in the up-down direction) of the fan 66. The bearings 64 and 65 are eccentric with respect to the motor shaft 61. A display plate 26, which indicates an eccentricity amount thereof, is disposed at the top portion of the front housing portion 21 (refer to FIG. 1). The fan 66 and the bearings 64 and 65 are interposed between a retainer 68 located below them and the bearing 63. The axial positions (positions in the up-down direction) of the bearing 63, 64, and 65 and the fan 66 are fixed by tightening a screw 69 inserted through the retainer 68 from below and extending into the motor shaft 61. Further, the pad 41 and the bearing box 67 are coupled using screws 45 inserted in the attachment holes 43 from below.

The above-described sander 10 operates in the following manner. First, when the user operates the switch button 51 to drive the electric motor 60, the motor shaft 61 starts rotating. The rotation of the motor shaft 61 is transmitted to the bearing box 67 supporting the bearings 64 and 65 via the bearings 64 and 65 eccentric with respect to the motor shaft 61. Accordingly, the bearing box 67 and the tool accessory 40 coupled with the bearing box 67 perform an eccentric circular motion and a rotational motion. When the sanding paper attached to the flat surface 42 of the pad 41 is pressed against a workpiece in this state, the workpiece is sanded.

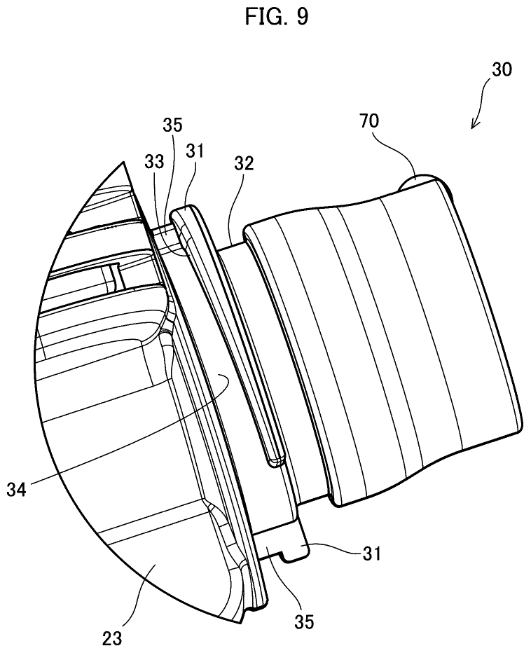

Now, a method for connecting the duct collection nozzle 30 and the dust collection device will be described. As illustrated in FIGS. 8 and 9, the dust collection nozzle 30 has a circular cylindrical shape in the present embodiment. Further, the dust collection nozzle 30 has a tapered shape reducing in diameter toward the distal end (the rear end) thereof. Two flange portions 31 and 31 for a twist lock are defined on the outer circumferential surface of the dust collection nozzle 30 near the proximal end of the dust collection nozzle 30. As will be used herein, the term “twist lock” refers to any engagement that can be established and released by a rotational operation. The two flange portions 31 and 31 are spaced apart from each other circumferentially, and extend circumferentially. Each of the flange portions 31 and 31 protrudes radially outward, as a result of which a groove 34 is defined between the rear surface of the rear housing portion 23 and the flange portions 31 and 31.

Each of the flange portions 31 and 31 includes a stopper 35 at one circumferential end thereof. The stopper 35 extends between the flange portion 31 or 31 and the rear surface of the rear housing portion 23, and closes the groove 34. The stopper 35 is not defined at the other circumferential end of each of the flange portions 31 and 31, as a result of which the groove 34 is opened. Each of the flange portions 31 and 31 includes a helical lead surface 33 (refer to FIG. 9) facing the rear surface of the rear housing portion 23. The lead surface 33 is defined in such a manner that the width of the groove 34 (the distance between the flange portion 31 and the rear surface of the rear housing portion 23) reduces from the one circumferential end toward the other circumferential end of the flange portion 31 or 31.

The dust collection nozzle 30 further includes a recessed portion 32 for press-fit engagement between the distal end of the dust collection nozzle 30 and the flange portions 31 and 31. In the present embodiment, the recessed portion 32 is adjacent to the flange portions 31 and 31. The recessed portion 32 is annularly defined along the outer circumferential surface of the dust collection nozzle 30. As will be used herein, the term “press-fit engagement” refers to any engagement relationship that can be established and released by an insertion/extraction operation.

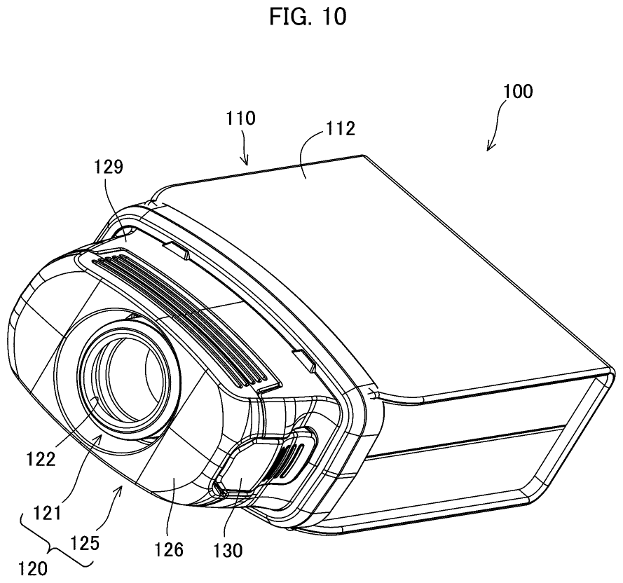

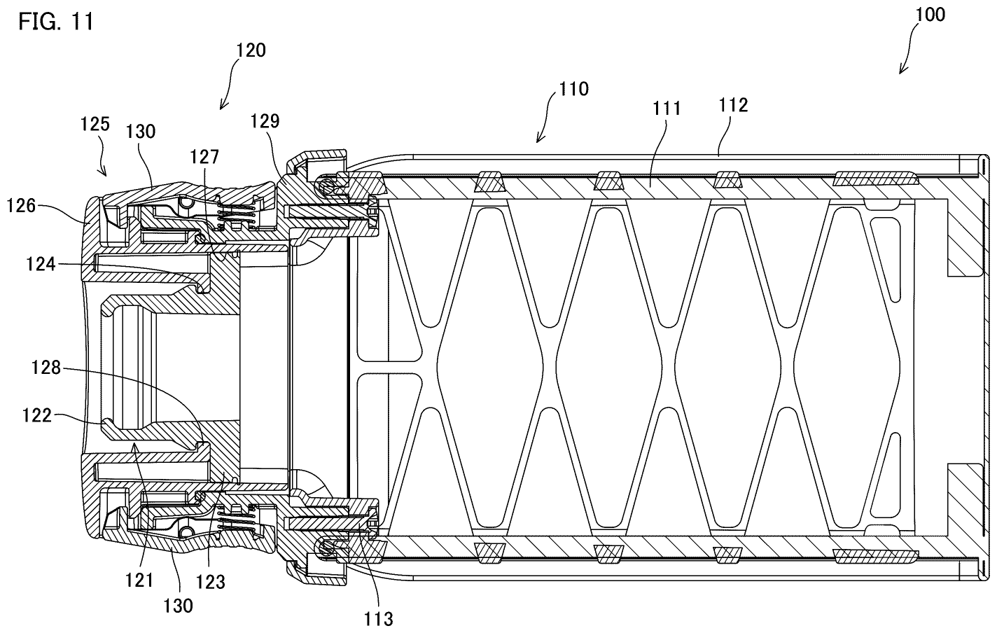

The dust collection nozzle 30 configured in this manner can be connected to various dust collection devices via a connector. At this time, the user can selectively connect a connector applicable to the twist lock and a connector applicable to the press-fit engagement. First, an example of the connector applicable to the press-fit engagement will be described. In the following description, a dust bag 100 according to the present embodiment as one example of the dust collection device is connected to the dust collection nozzle 30. As illustrated in FIGS. 10 and 11, the dust bag 100 includes a bag main body 110 and a connector 120. The bag main body 110 includes a frame 111 and a bag 112 fixed to the frame 111 so as to surround the frame 111. The bag 112 is generally rectangularly shaped. The frame 111 has an outline slightly smaller than the bag 112, and is shaped to maintain the shape of the bag 112.

The connector 120 includes a rubber sleeve 121 and a cover 125. A through-hole of the rubber sleeve 121 is in communication with the inside of the bag main body 110. The rubber sleeve 121 includes, at the rear edge thereof, a protrusion portion 123 that protrudes radially outward. The protrusion portion 123 extends annularly along the circumferential direction. The rubber sleeve 121 further includes a recessed portion 124 adjacent to the protrusion portion 123 in front of the protrusion portion 123. The recessed portion 124 extends annularly along the circumferential direction. The rubber sleeve 121 further includes, at the front edge thereof, a protrusion portion 122 that protrudes radially inward. The protrusion portion 122 is defined due to an annular groove being defined on the inner circumferential surface of the rubber sleeve 121 in the rear of the protrusion portion 122.

The cover 125 is disposed outside the rubber sleeve 121 so as to surround the rubber sleeve 121. More specifically, the cover 125 includes a sleeve holding portion 126, a connection portion 129, and two operation members 130. The sleeve holding portion 126 is tubularly shaped, and circumferentially surrounds the rubber sleeve 121. The sleeve holding portion 126 includes a recessed portion 127 and a protrusion portion 128. The recessed portion 127 extends annularly along the circumferential direction on the inner surface of the sleeve holding portion 126. The protrusion portion 128 is located in front of the recessed portion 127 and protrudes radially inward, and extends annularly along the circumferential direction.

The rubber sleeve 121 is held by the sleeve holding portion 126 in a state of being fitted in the sleeve holding portion 126. At this time, the protrusion portion 123 of the rubber sleeve 121 is fitted in the recessed portion 127 of the sleeve holding portion 126, and the protrusion portion 128 of the sleeve holding portion 126 is fitted in the recessed portion 124 of the rubber sleeve 121. Due to that, the rubber sleeve 121 is restricted from moving radially and axially relative to the sleeve holding portion 126. The rubber sleeve 121 is made of rubber, and therefore can be easily attached to the sleeve holding portion 126 using elastic deformation of the rubber sleeve 121. The rubber sleeve 121 is attached in the sleeve holding portion 126 in such a manner that the front end thereof is located at a position deeper (closer to the rear side) than the front end of the sleeve holding portion 126.

The connection portion 129 is tubularly shaped, and the sleeve holding portion 126 is fitted inside the connection portion 129. The rear edge portion of the connection portion 129 is coupled with the frame 111 using screws 113. The two operation members 130 are attached to the outer surface of the connection portion 129. Each of the operation members 130 is configured to be displaceable between an engagement position at which the front edge thereof is engaged with the sleeve holding portion 126, and a disengagement position by a manual operation. When the operation member 130 is located at the engagement position, this engagement restricts a movement of the sleeve holding portion 126 relative to the connection portion 129. When the operation member 130 is located at the disengagement position, the sleeve holding portion 126 can be extracted out of the connection portion 129 by axially moving the sleeve holding portion 126 relative to the connection portion 129.

The dust bag 100 configured in this manner can be connected to the sander 10 by press-fitting the dust collection nozzle 30 of the sander 10 into the rubber sleeve 121. Therefore, the dust bag 100 can be attached and detached with an easy operation. Further, the protrusion portion 122 of the rubber sleeve 121 is fitted in the recessed portion 32 of the dust collection nozzle 30 with the dust collection nozzle 30 press-fitted in the rubber sleeve 121. Therefore, the connection force between the connector 120 and the dust connection nozzle 30 can be enhanced compared to a structure in which tapered tubular bodies not having a recess and a protrusion are fitted to each other. Further, such a connection using the press-fit engagement is free from constraints on the rotational angle position of the connector 120 relative to the sander 10, thereby allowing the dust bag 100 to be attached to the sander 10 at a desired rotational angle position. Such a rotational angle position is normally a position where the height of the dust bag 100 is minimized.

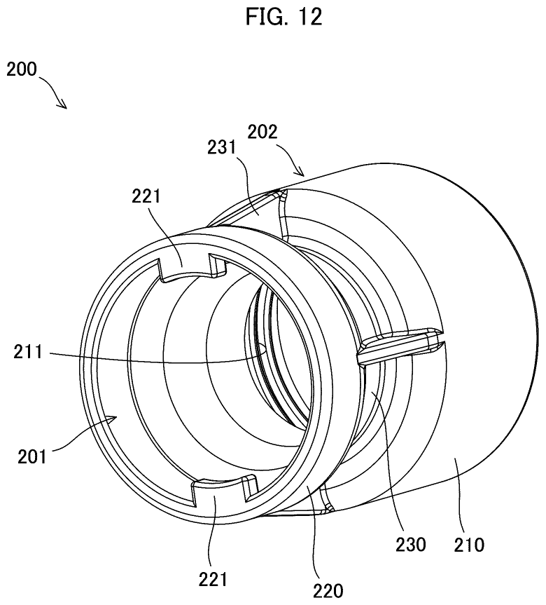

Next, an example of the connector applicable to the twist lock will be described. In the following description, a connector 200 according to the present embodiment is connected to the dust collection nozzle 30. The connector 200 is also referred to as a cuff. As illustrated in FIG. 12, the connector 200 has a generally circular cylindrical shape, and includes a through-hole 201 at the center thereof. The connector 200 includes a large-diameter portion 210, a small-diameter portion 220, and a connection portion 230 connecting the large-diameter portion 210 and the small-diameter portion 220. The large-diameter portion 210 includes a helical engagement groove 211 on the inner circumferential surface thereof. The engagement groove 211 is used for a direct or indirect connection to any dust conveyance means (for example, a hose having a connector). The connector 200 and the dust conveyance means can be connected by threadedly inserting the dust conveyance means having an externally threaded shape in conformity with the engagement groove 211 into the large-diameter portion 210.

The small-diameter portion 220 is smaller in outer diameter and inner diameter than the large-diameter portion 210. Two claw portions 221 for the twist lock are defined at the edge portion of the small-diameter portion 220 (the edge portion opposite from the connection portion 230). The two claw portions 221 are spaced apart from each other circumferentially. Each of the claw portions 221 protrudes radially inward. The connection portion 230 is smaller in outer diameter and inner diameter than the small-diameter portion 220. A plurality of reinforcement ribs 231 is defined on the outer circumferential surface of the connection portion 230.

The connector 200 configured in this manner can be connected to the sander 10 by inserting the dust collection nozzle 30 into the connector 200 and rotating the connector 200. More specifically, the user first inserts the connector 200 in such a manner that the two claw portions 221 pass forward through spaces between the two flange portions 31 of the dust collection nozzle 30. Next, the user rotates the connector 200 in such a manner that the claw portions 221 approach the stoppers 35 by passing through inside the groove 34. This rotational operation continues until an axial force is acquired to the degree that a further rotation is prohibited by the lead surfaces 33 or the claw portions 221 are brought into abutment with the stoppers 35. According to such engagement between the flange portions 31 and the claw portions 221, the connection force between the connector 200 and the dust collection nozzle 30 is enhanced and makes it difficult for the connector 200 to be disengaged from the dust collection nozzle 30. Especially, the flange portions 31 include the lead surfaces 33, and therefore the axial force is added to the engagement between the flange portions 31 and the claw portions 221, which can facilitate a further robust connection between the dust collection nozzle 30 and the connector 200. However, the flange portions 31 may not include the lead surfaces 33. In other words, the front side surfaces of the flange portions 31 may be defined in such a manner that the groove 34 is kept constant in width circumferentially.

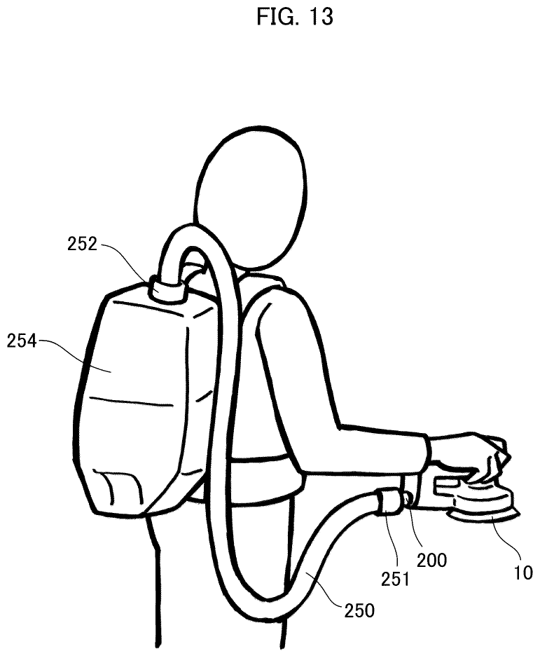

The connector 200 configured in this manner is, for example, usable in a manner illustrated in FIG. 13. In this example, the small-diameter portion 220 is connected to the dust collection nozzle 30 of the sander 10 according to the above-described procedure, and one end of a hose 250 is connected to the large-diameter portion 210 via a sleeve 251 having an externally threaded shape in conformity with the engagement groove 211. The other end of the hose 250 is connected to a dust collector 254 serving as one example of the dust collection device via a sleeve 252. The dust collector 254 is configured to allow a person to carry it on his/her back. The dust collector 254 is also referred to as a knapsack-type dust collector.

In the above-described manner, according to the dust collection nozzle 30, the connector 200 having the twist lock structure and the connector 120 having the press-fit engagement structure can be selectively attached to the dust collection nozzle 30. This leads to an increase in the number of types of connectors attachable to the dust collection nozzle 30, thereby improving the versatility of the dust collection nozzle 30. Therefore, the sander 10 and the dust collection device can be connected to each other with improved convenience.

In the following description, an antistatic measure at the sander 10 and the connector 120 or 200 will be described. First, the antistatic measure when the connector 120 is connected to the dust collection nozzle 30 will be described. The rubber sleeve 121 of the connector 120 is made of a conductive material. On the other hand, the cover 125 of the connector 120 is made of an insulating material. In this manner, the cover 125 made of an insulating material is arranged outside the rubber sleeve 121 so that the rubber sleeve 121 is not exposed, and therefore an unpleasant electric discharge from the connector 120 to the user's hand does not occur even when the dust bag 100 is charged with static electricity of a high potential at the connector 120 due to the dust.

Further, the static electricity with which the dust bag 100 is charged can be released from the rubber sleeve 121 made of the conductive material to the sander 10. More specifically, the dust collection nozzle 30 is made of an insulating material. Therefore, an unpleasant electric discharge from the dust collection nozzle 30 to the user's hand does not occur. As illustrated in FIG. 5, a metallic earth wire 70 is disposed in the dust collection passage 29. As illustrated in FIGS. 5 and 8, one end of the earth wire 70 has a ring-like shape, and is exposed by protruding from the outer circumferential surface of the dust collection nozzle 30 via a slit of the dust collection nozzle 30 at the distal end of the dust collection nozzle 30. Therefore, the earth wire 70 is in contact with the rubber sleeve 121 made of the conductive material with the connector 120 attached to the dust collection nozzle 30. As illustrated in FIG. 5, the other end of the earth wire 70 is in contact with an outer race of the bearing 63.

The bearing 63, the motor shaft 61, the fan 66, the bearings 64 and 65, the bearing box 67, and the screws 45 are metallic, and are in contact sequentially to allow an electric current to flow through them. Therefore, the static electricity of the dust bag 100 can be released from the rubber sleeve 121 to the screws 45 via the earth wire 70, the bearing 63, the motor shaft 61, the fan 66, the bearings 64 and 65, and the bearing box 67. Then, the static electricity released to the screws 45 is discharged from the heads of the screws 45 to the workpiece beyond the sanding paper attached to the flat surface 42 of the tool accessory 40. As a result, the dust bag 100 can be prevented from being charged with static electricity of a high potential. According to this configuration, the static electricity with which the dust bag 100 is charged can be efficiently released via the metallic earth wire 70. Further, the metallic power transmission member (the motor shaft 61, the bearings 64 and 65, and the bearing box 67) and other components originally existing in the sander 10 are used as the route for releasing the static electricity, and this reduces the necessity of additional members and specifications for releasing the static electricity, thereby contributing to the simplification of the apparatus configuration.

Next, the antistatic measure when the connector 200 is connected to the dust collection nozzle 30 will be described. The hose 250 has a two-layered structure (or a dual structure) with the inside made of a conductive material and the outside made of an insulating material. The sleeves 251 and 252 are made of insulating materials, but may have a two-layered structure with the inside made of a conductive material and the outside made of an insulating material similarly to the hose 250. The connector 200, in particular, at least the outer surface 202 thereof is made of a static dissipative material. The static dissipative material used for the connector 200 is, for example, static dissipative ABS resin. The static dissipative material may also be referred to as an antistatic material. In the present embodiment, the connector 200 is entirely made of the static dissipative material. The static dissipative material is a material less electrostatically chargeable and highly contributive to comparatively quick dissipation of static electricity. The static dissipative material can be defined to be, for example, a material having surface resistivity equal to or higher than 1×10⁵ (Ω/sq.) and equal to or lower than 1×10¹³ (Ω/sq.).

According to the connector 200, at least the outer surface 202 is made of the static dissipative material, and this makes it difficult for the unpleasant electric discharge from the connector 200 to the user's hand to occur even when the user brings his/her hand close to the connector 200 in a state that the range from the connector 200 to the dust collector 254 is charged with static electricity of a high potential, compared with when the outer surface 202 is made of a conductive material. Further, since at least the outer surface 202 of the connector 200 is made of the static dissipative material, the static electricity accumulated at a portion closer to the dust collector 254 than the connector 200 can be released to the sander 10 via the inner portion (the portion made of the conductive member) of the hose 250 and the connector 200 compared with when the outer surface 202 is made of an insulating material. This makes it difficult for the range between the connector 200 and the dust collector 254 to be charged with static electricity of a high potential. The route for releasing the static electricity to the sander 10 via the connector 200 subsequent to the earth wire 70 in contact with the connector 200 is set in a similar manner to the above-described route.

The surface resistivity of the static dissipative material used for the connector 200 may be, for example, equal to or higher than 1×10⁷ (Ω/sq.) and equal to or lower than 1×10¹² (Ω/sq.). Using such a material facilitates the release of the static electricity to the sander 10 via the connector 200 while further reliably reducing or removing the unpleasant electric discharge.

In the following description, a second embodiment will be described. The apparatus configuration of the second embodiment is similar to the first embodiment. In the following description, the second embodiment will be described focusing only on differences from the first embodiment. In the second embodiment, the display plate 26 disposed on the top portion of the front housing portion 21 (i.e., the first grip portion gripped by the user during machining work) is entirely made of conductive resin or a static dissipative material. The display plate 26 may be made of conductive elastomer. This material selection allows the user to feel an excellent fit when gripping the first grip portion.

As illustrated in FIG. 5, the display plate 26 includes a protrusion portion 27 protruding downward as far as near the outer race of the bearing 62. The separation distance between the protrusion portion 27 and the outer race of the bearing 62 is a distance through which the static electricity can be discharged (for example, several millimeters). The protrusion portion 27 and the outer race of the bearing 62 may be in contact with each other. The bearing 62 is a metallic component.

In the second embodiment, an additional route is secured in addition to the above-described route for releasing the static electricity from the earth wire 70. More specifically, the additional route is a route passing through the earth wire 70, the bearing 63, the motor shaft 61, the bearing 62, and the protrusion portion 27 (i.e., the display plate 26). The display plate 26 is a portion gripped by the user during the machining work, and therefore securing this route allows the connector 120 or the connector 200 and the display plate 26 (and thus the user gripping the first grip portion including the display plate 26) to be kept at equal potentials constantly during the machining work. This makes it further difficult for the electric discharge considerable to the degree that the user feels unpleasant to occur.

A part of the display plate 26 including a part of the outer surface of the display plate 26 may be made of conductive resin or a static dissipative material instead of the display plate 26 being entirely made thereof. In this case, the portion made of conductive resin or a static dissipative material is arranged so as to allow the static electricity to be released from the bearing 62 to the outer surface of the display plate 26. Alternatively, the portion made of conductive resin or a static dissipative material may be arranged at the portion gripped by the user around the display plate 26 so as to allow the static electricity to be released from the bearing 62 to the outer surface of the display plate 26. Alternatively, in the case where the sander 10 is unequipped with the display plate 26, the top portion of the front housing portion 21 may be entirely or partially made of conductive resin or a static dissipative material so as to allow the static electricity to be released from the bearing 62 to the outer surface of the top portion of the front housing portion 21.

The corresponding relationship between each component in the above-described embodiments and each component of the claims will be described below. However, each component in the embodiments is merely one example and shall not limit each component of the claims. The sander 10 is one example of a “machining apparatus”. The connectors 120 and 200 are one example of a “connector”. The dust bag 100 and the dust collector 254 are one example of a “dust collection device”. The through-hole 201 is one example of a “through-hole”. The outer surface 202 is one example of an “outer surface”. The claw portion 221 is one example of a “claw portion for a twist lock”. The rubber sleeve 121 is one example of a “rubber sleeve”. The protrusion portion 122 is one example of a “protrusion portion”. The dust collection nozzle 30 is one example of a “dust collection nozzle”. The earth wire 70 is one example of an “earth member”. The motor shaft 61, the bearings 62, 63, 64, and 65, and the bearing box 67 are one example of a “power transmission member”. The top portion of the front housing portion 21 is one example of a “grip portion”. The electric motor 60 is one example of a “direct-current motor”. The cover 125 is one example of a “cover”. The flange portion 31 is one example of a “first engagement portion” and a “flange portion”. The recessed portion 32 is one example of a “second engagement portion” and a “recessed portion”.

Having described embodiments, the above-described embodiments are intended to only facilitate the understanding of the present teachings, and are not intended to limit the present invention thereto. The present invention can be modified or improved without departing from the spirit thereof, and the present invention includes equivalents thereof. Further, each of the elements described in the claims and the specification can be combined or omitted in any manner within a range that allows it to remain capable of solving at least a part of the above-described problems or bringing about at least a part of the above-described advantageous effects.

For example, the rubber sleeve 121 may include a recessed portion instead of the protrusion portion 122. In this case, the dust collection nozzle 30 may include a protrusion portion engageable with the recessed portion of the rubber sleeve 121 instead of the recessed portion 32.

Further, the route for releasing the static electricity from the connector 120 or the connector 200 to outside via the sander 10 is not limited to the above-described example, and may be secured using any conductive member.

Further, the engagement structure between the connector 120 or the connector 200 and the dust collection nozzle 30 is not limited to the above-described example, and can be modified to any engagement structure. For example, the engagement structure between the connector 120 and the dust collection nozzle 30 may be modified to a structure in which tapered tubular bodies not having a recess and a protrusion are fitted to each other or may be modified to an engagement structure using a twist lock. In the case of the latter, the position of the stopper 35 may be set so as to allow the connector 120 to be attached to the dust collection nozzle 30 at an appropriate rotational angle position relative to the dust collection nozzle 30. Alternatively, the engagement structure between the connector 200 and the dust collection nozzle 30 may be modified to a press-fit engagement structure.

Further, the above-described various engagement structures between the connector 120 or the connector 200 and the dust collection nozzle 30, and the above-described configurations for the antistatic measure may be implemented independently of each other.

Further, the above-described embodiments are applicable to not only random orbit sanders but also various machining apparatuses connectable to a dust collection device, such as other various types of sanders, portable circular saws, sliding circular saws, grinders, drills, and rotary hammers.

### DESCRIPTION OF THE REFERENCE NUMERALS

10 sander, 20 housing, 21 front housing portion, 22 connection portion, 23 rear housing portion, 24 intake port, 25 exhaust port, 26 display plate, 27 protrusion portion, 28 containing space, 29 dust collection passage, 30 dust collection nozzle, 31 flange portion, 32 recessed portion, 33 lead surface, 34 groove, 35 stopper, 40 tool accessory, 41 pad, 42 flat surface, 43 attachment hole, 44 flow hole, 45 screw, 50 controller, 51 switch button, 51a hinge shaft, 52 switch unit, 53 power connector jack, 54 switch holder, 60 electric motor, 61 motor shaft, 62, 63, 64, 65 bearing, 66 fan, 67 bearing box, 68 retainer, 69 screw, 70 earth wire, 100 dust bag, 110 bag main body, 111 frame, 112 bag, 113 screw, 120 connector, 121 rubber sleeve, 122 protrusion portion, 123 protrusion portion, 124 recessed portion, 125 cover, 126 sleeve holding portion, 127 recessed portion, 128 protrusion portion, 129 connection portion, 130 operation member, 200 connector, 201 through-hole, 202 outer surface, 210 large-diameter portion, 211 engagement groove, 220 small-diameter portion, 221 claw portion, 230 connection portion, 231 reinforcement rib, 250 hose, 251, 252 sleeve, 254 dust collector

1. A connector configured to directly or indirectly connect a machining apparatus and a dust collection device, the connector comprising:
a through-hole configured to establish communication between the machining apparatus and the dust collection device; and
an outer surface made of a static dissipative material.

2. The connector according to claim 1, wherein surface resistivity of the outer surface is equal to or higher than 1×10⁵ (Ω/sq.) and equal to or lower than 1×10¹³ (Ω/sq.).

3. The connector according to claim 2, wherein the surface resistivity of the outer surface is equal to or higher than 1×10⁷ (Ω/sq.) and equal to or lower than 1×10¹² (Ω/sq.).

4. The connector according to claim 1, further comprising a claw portion for a twist lock, the claw portion being usable for the connection to the machining apparatus.

5. The connector according to claim 1, further comprising a rubber sleeve including an inner circumferential surface with a circumferentially extending recessed portion and/or protrusion portion defined thereon.

6. A machining apparatus comprising:
the connector according to claim 1; and
a dust collection nozzle connectable to the connector.

7. The machining apparatus according to claim 6, further comprising a metallic earth member disposed in contact with the connector with the connector attached to the dust collection nozzle.

8. The machining apparatus according to claim 6, further comprising a metallic power transmission member,
wherein the machining apparatus is configured to release static electricity from the connector to the power transmission member.

9. The machining apparatus according to claim 6, further comprising a grip portion configured to be held by a user with his/her hand during machining,
wherein the machining apparatus is configured to release the static electricity from the connector to the grip portion.

10. The machining apparatus according to claim 9, wherein the grip portion includes an outer surface at least partially made of conductive resin or a static dissipative material.

11. The machining apparatus according to claim 10, wherein the outer surface of the grip portion is at least partially made of conductive elastomer.

12. The machining apparatus according to claim 9, further comprising a direct-current motor disposed right below the grip portion.

13. A connector configured to directly or indirectly connect a machining apparatus and a dust collection device, the connector comprising:
a rubber sleeve made of a conductive material and including an inner circumferential surface with a circumferentially extending recessed portion and/or protrusion portion defined thereon; and
a cover made of an insulating material and disposed outside the rubber sleeve so as to surround the rubber sleeve.

14. A machining apparatus comprising:
a dust collection nozzle usable to discharge dust generated due to machining out of the machining apparatus,
the dust collection nozzle including a first engagement portion for a twist lock and a second engagement portion for press-fit engagement.

15. The machining apparatus according to claim 14, wherein the dust collection nozzle has a generally circular cylindrical shape, and
the first engagement portion includes a flange portion defined on an outer circumferential surface of the dust collection nozzle engageably with a claw portion of a connector configured to directly or indirectly connect the dust collection nozzle to a dust collection device.

16. The machining apparatus according to claim 15, wherein the flange portion has a helical lead surface.

17. The machining apparatus according to claim 15, wherein the second engagement portion includes a protrusion portion and/or a recessed portion circumferentially extending on the outer circumferential surface of the dust collection nozzle engageably with a recessed portion and/or a protrusion portion extending circumferentially on an inner circumferential surface of a rubber sleeve of the connector, and
the protrusion portion and/or the recessed portion of the second engagement portion is located between a distal end and the flange portion of the dust collection nozzle.

18. The connector according to claim 1, further comprising:
a claw portion for a twist lock, the claw portion being usable for the connection to the machining apparatus; and
a rubber sleeve including an inner circumferential surface with a circumferentially extending recessed portion and/or protrusion portion defined thereon.

19. The machining apparatus according to claim 6, further comprising:
a metallic power transmission member; and
a grip portion configured to be held by a user with his/her hand during machining,
wherein the machining apparatus is configured to release static electricity from the connector to the power transmission member and to release the static electricity from the connector to the grip portion.
